(19) United States
(12) Patent Application Publication
(10) Pub. No.: US 2021/0231382 A1
(43) Pub. Date: Jul. 29, 2021

(54) PLATE HEAT EXCHANGER, PROCESS ENGINEERING SYSTEM AND METHOD

(71) Applicant: LINDE GMBH, Pullach (DE)

(72) Inventors: Manfred Steinbauer, Raisting (DE); Rainer Flüggen, Bichl (DE); Axel Lehmacher, Egling-Moosham (DE); Clemens Baumgartner, Geretsried (DE); Konrad Braun, Lenggries (DE); Rainer Hoffmann, Unterhaching (DE); Alexander Woitalka, München (DE); Stefan Gewald, Neuried (DE); Janine Blank, Kienberg (DE); Christiane Kerber, Pöcking (DE)

(21) Appl. No.: 17/051,122

(22) PCT Filed: Apr. 17, 2019
(86) PCT No.: PCT/EP2019/025110

§ 371 Date: Oct. 27, 2020

(30) Foreign Application Priority Data
Apr. 27, 2018 (DE) 10 2018 003 479.9

(51) Int. Cl. F28D 9/00; F28F 3/12

(52) U.S. Cl. CPC F28D 9/0062; G01K 11/32; F28F 3/12

(57) ABSTRACT

The invention relates to a plate heat exchanger (1) for a process engineering system (2), having a plurality of lamellae (3, 4) and a plurality of separating plates (5-7), which are arranged alternately, wherein at least one separating plate (6) has an optical waveguide (35) that is embedded in the at least one separating plate (6) in such a way that the optical waveguide (35) is covered on both sides by material of the at least one separating plate (6) in a first direction (R1) and in a second direction (R2), which are each oriented perpendicular to a plane (E) defined by the at least one separating plate (6) and in opposite senses with respect to one another.

The invention relates to a plate heat exchanger for a process engineering system, a process engineering system having such a plate heat exchanger, and a method for producing such a plate heat exchanger.

So-called plate heat exchangers comprise a plurality of lamellae or fins, between which separating plates are arranged. The separating plates separate adjacent heat transfer passages from one another in such a way that a material transition between the heat transfer passages is prevented, but heat transfer is made possible. However, thermal stresses due to different thermal expansions from differential temperature differences can lead to mechanical damage to the tightness between the heat transfer passages up to the leakage of the plate heat exchanger with respect to its surroundings. To analyze the temperature field, such a plate heat exchanger can be equipped, for example, with a temperature measurement on a surface of its outer skin. However, the temperatures on the outer skin provide only a local value, with which, under certain assumptions, conclusions can be drawn about the temperature in the interior of the plate heat exchanger. However, these temperature measurements can be influenced by environmental influences on account of the measurement on the outer skin.

WO 2014/056587 A1 describes a plate heat exchanger with an optical waveguide for temperature measurement. The optical waveguide in this case is positioned in an open groove which is provided either in a lamella or in a separating plate of the plate heat exchanger.

Against this background, the aim of the present invention is to provide an improved heat exchanger.

To this end, the invention proposes a plate heat exchanger for a process engineering system. The invention relates to a plate heat exchanger having a plurality of lamellae and a plurality of separating plates, which are arranged alternately, wherein at least one separating plate has an optical waveguide that is embedded in the at least one separating plate in such a way that the optical waveguide is covered by material of the at least one separating plate in a first direction and in a second direction, which are each oriented perpendicular to a plane defined by the at least one separating plate and in opposite senses with respect to one another.

Due to the fact that the optical waveguide is arranged within the separating plate, damage to the optical waveguide can, on the one hand, be prevented. On the other, a high-resolution and exact measurement of the temperature directly in the separating plate and thus also in the interior of the plate heat exchanger is possible. Since the optical waveguide is integrated into the separating plate, no additional or at least only a little additional installation space is required for detecting the temperature distribution and/or expansion distribution. Since the separating plate is arranged inside the plate heat exchanger, the measured temperature is not influenced by ambient influences.

Both strain measurements and temperature measurements can be carried out with the aid of the optical waveguide. The increase in component reliability against failure or inward or outward leakage is increased.

The fact that the lamellae and the separating plates are arranged “alternately” means that a separating plate is arranged between two lamellae, and a lamella is arranged between two separating plates. The number of lamellae and the number of separating plates is basically arbitrary. The plates and the separating plates are positioned, in particular, between two cover plates of the plate heat exchanger. Layers formed by the lamellae—so-called lamellar layers—form so-called passages—in particular, heat transfer passages—which are separated from the surroundings by edge strips or sidebars. The optical waveguide is preferably an optical fiber sensor cable. The optical waveguide can thus be a sensor element of a measuring device of the plate heat exchanger. The fact that the optical waveguide is “embedded” in the at least one separating plate means that the optical waveguide is arranged completely within the separating plate. The plane defined by the at least one separating plate preferably runs centrally through the at least one separating plate in such a way that it is preferably constructed mirror-symmetrically with respect to the plane.

The at least one separating plate preferably has a rectangular geometry, wherein the separating plate can have a thickness of about 1 to 2 mm. The at least one separating plate is thus not, or only slightly, thicker than a separating plate without such an optical waveguide. The separating plates can be referred to as separating sheets. The lamellae may be referred to as fins. Several separating plates can be provided with such an optical waveguide. The at least one separating plate preferably comprises at least one optical waveguide. Furthermore, the at least one separating plate can comprise several—in particular, different—optical waveguides. The lamellae may have a corrugated or stepped geometry. Due to the embedded optical waveguide, the at least one separating plate can be referred to as an intelligent separating plate.

The plane defined by the separating plate is a main plane of extension of the separating plate. That is, the separating plate extends in a sheet-like or plate-like manner in the plane. The plane is defined, in particular, by a width direction and a depth direction of the separating plate. The plane is, in particular, not defined by a thickness direction of the separating plate. Rather, the thickness direction is oriented perpendicular to the plane. In the present case, “perpendicular” is to be understood to mean an angle of 90°±10°, more preferably of 90°±5°, more preferably of 90°±1°, and more preferably of exactly 90°. The width direction, the depth direction, and the thickness direction constitute a coordinate system of the at least one separating plate. In this case, the thickness direction can coincide with one of the directions positioned perpendicularly to the plane. This means that the optical waveguide is covered or concealed on two sides or both sides by the material of the separating plate—in particular, in the thickness direction of the separating plate.

The optical waveguide being covered on “both sides” or “two sides” by the material of the separating plate is to be understood as meaning that, considered both in the first direction and in the second direction, the optical waveguide is covered both on the upper side and also on the lower side by the material of the separating plate. The first direction and the second direction being oriented “in opposite senses” is to be understood as meaning that the two directions point away from each other. In particular, the first direction is oriented in parallel to the second direction. In particular, the two directions are positioned at an angle of 180° to each other.

In one embodiment, the plate heat exchanger comprises a first lamella and a second lamella, wherein the at least one separating plate is disposed between the first lamella and the second lamella, and wherein the optical waveguide is embedded in the at least one separating plate such that the optical waveguide is covered by the material of the at least one separating plate both in the direction of the first lamella and in the direction of the second lamella.

As mentioned above, the number of lamellae is arbitrary. A separating plate is arranged in each case between two lamellae, and vice versa. The fact that the optical waveguide is covered by the material of the at least one separating plate both in the direction of the first lamella and in the direction of the second lamella means that the separating plate is arranged both between the first lamella and the optical waveguide and between the second lamella and the optical waveguide. That is to say, the optical waveguide does not make direct contact with one of the lamellae.

In a further embodiment, the at least one separating plate has a first separating plate portion and a second separating plate portion, between which the optical waveguide is arranged.

The first separating plate portion and the second separating plate portion can each be designed as sheets—in particular, as aluminum sheets or steel sheets. For example, the first separating plate portion and the second separating plate portion have an identical thickness or different thicknesses. For example, the first separating plate portion is positioned between the optical waveguide and the first lamella, and the second separating plate portion is positioned between the optical waveguide and the second lamella, or vice versa.

In another embodiment, the first separating plate portion and the second separating plate portion are bonded to each other by a solder.

In the case of bonded connections, the connection partners are held together by atomic or molecular forces. Bonded connections are non-releasable connections which can be detached from one another only by destroying the connecting means—in this case, the solder—or the connection partners—in this case, the separating plate portions. The separating plate portions may also be welded together.

In another embodiment, the optical waveguide is embedded in the solder.

In this case, a support structure or a spacer may be provided, which is disposed between the first separating plate portion and the second separating plate portion. The spacer has a greater thickness than a diameter of the optical waveguide. For example, the optical waveguide has a diameter of 125 μm. A thickness of the solder or a solder layer or the spacer may be 170 μm. The spacer may be embedded in the solder.

In a further embodiment, the first separating plate portion and/or the second separating plate portion have a groove in which the optical waveguide is arranged.

The groove may form a cavity within the at least one separating plate. For example, the groove is provided in the first separating plate portion and is closed upwards with the aid of the second separating plate portion. The groove may also be provided in the second separating plate portion or in both separating plate portions. The optical waveguide can be accommodated so as to move freely in the groove. Alternatively, the groove can also be filled with the solder, so that the optical waveguide is embedded in the solder. The groove can pass through the at least one separating plate as a straight, zigzagged, or meandering shape.

In another embodiment, the optical waveguide is completely surrounded by the material of the at least one separating plate.

In this case, preferably, no solder is provided. For this purpose, the at least one separating plate is constructed around the optical waveguide. In this case, a so-called generative or additive production method, such as selective laser sintering (SLS) or the like, can be used. In particular, a powder-based generative production method is used. The at least one separating plate is thus produced additively or generatively.

In another embodiment, the at least one separating plate is formed in one piece.

That is, the at least one separating plate is continuously made of the same material. For this purpose, the at least one separating plate can be produced with, for example, the aid of the aforementioned generative production method. The fact that the at least one separating plate is produced with the aid of a generative production method can, for example, be detected microscopically by a layered or layer-by-layer construction of the at least one separating plate.

In a further embodiment, the optical waveguide is accommodated in a sleeve.

The sleeve is preferably a metal sleeve. The sleeve may be embedded in the solder. The optical waveguide is preferably accommodated in the sleeve in a linearly, axially displaceable manner.

The invention also relates to a process engineering system having such a plate heat exchanger.

The process engineering system can, for example, be a system for air separation or for liquid gas generation, or a system used in the petrochemical industry. The process engineering system may comprise a plurality of such plate heat exchangers.

The invention also relates to a method for producing a plate heat exchanger for a process engineering system. The method comprises the following steps: a) providing a plurality of plates, b) providing a plurality of separating plates, c) providing an optical waveguide, d) embedding the optical waveguide in at least one separating plate in such a way that the optical waveguide is covered on both sides by material of the at least one separating plate in a first direction and in a second direction, which are each oriented perpendicular to a plane defined by the at least one separating plate and in opposite senses to one another, and e) alternately arranging the lamellae and the separating plates.

In step c), in particular, at least one optical waveguide is provided. However, several—in particular, also different—optical waveguides can also be provided. The step d) may, alternatively, also comprise embedding the aforementioned sleeve in such a way that the sleeve is covered on both sides by material of the at least one separating plate in the first direction and in the second direction. The sleeve can also be embedded together with the optical waveguide. In this case, the optical waveguide is inserted into the sleeve before embedding it. Alternatively, the optical waveguide can also be introduced into the sleeve after embedding the sleeve. Steps a) through e) need not be performed in alphabetical order. For example, the embedding of the, in particular, at least one optical waveguide or also of the sleeve into the at least one separating plate can already take place in step b), viz., when the plurality of separating plates is provided. A plurality of separating plates can be provided, into each of which an optical waveguide or a sleeve is embedded. However, at least one such separating plate is preferably provided.

In one embodiment, in step d), the optical waveguide is arranged between a first separating plate portion and a second separating plate portion of the at least one separating plate.

In the directions oriented perpendicular to the plane defined by the at least one separating plate, the first separating plate portion and the second separating plate portion cover the optical waveguide on two sides or on both sides, so that this is covered or concealed on both sides by the material of the separating plate.

In a further embodiment, in step d), the first separating plate portion and the second separating plate portion are bonded to each other by means of a solder.

In this case, the optical waveguide or the sleeve in which the optical waveguide is accommodated can be embedded in the solder. The separating plate portions may also be welded together.

In a further embodiment, in step d), the optical waveguide or a sleeve in which the optical waveguide can be received is embedded in the solder and/or arranged in a groove which has the first separating plate portion and/or the second separating plate portion.

The groove may be filled with the solder. The groove may also be solder-free, so that the optical waveguide is movable in the groove. The groove may be provided in either the first separating plate portion, the second separating plate portion, or in both the first separating plate portion and the second separating plate portion. The groove may be rectangular. However, the groove can also have any other geometry.

In a further embodiment, in step d), the at least one separating plate is constructed around the optical waveguide with the aid of a generative manufacturing method.

The generative manufacturing method may also be referred to as an additive manufacturing method. Examples of generative manufacturing methods are, for example, selective laser melting (SLM), selective laser sintering (SLS), or similar methods. The at least one separating plate is preferably produced by means of a so-called powder bed method. That is, the at least one separating plate is constructed of a powder. In particular, a 3-D printing method can be used for this purpose. However, other generative manufacturing methods may also be used.

Further possible implementations of the plate heat exchanger, the process engineering system, and/or the method also include not explicitly mentioned combinations of features or embodiments described above or below with respect to the exemplary embodiments. The person skilled in the art will also add individual aspects as improvements or supplements to the respective basic form of the plate heat exchanger, the process engineering system, and/or the method.

Further advantageous embodiments and aspects of the plate heat exchanger, of the process engineering system, and/or of the method are the subject matter of the subclaims and of the exemplary embodiments of the plate heat exchanger, the process engineering system, and/or the method described below. Furthermore, the plate heat exchanger, the process engineering system, and/or the method are explained in more detail with reference to the enclosed figures on the basis of preferred embodiments.

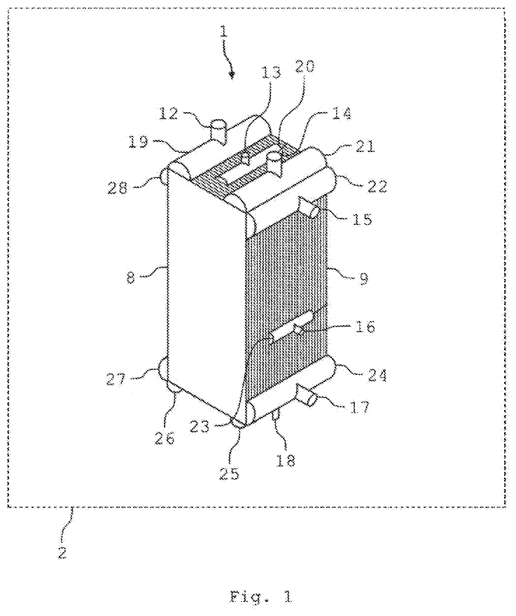

FIG. 1 shows a schematic perspectival view of an embodiment of a plate heat exchanger;

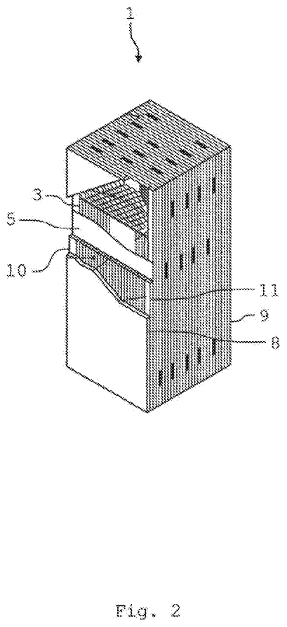

FIG. 2 shows a further schematic perspectival view of the plate heat exchanger according to FIG. 1;

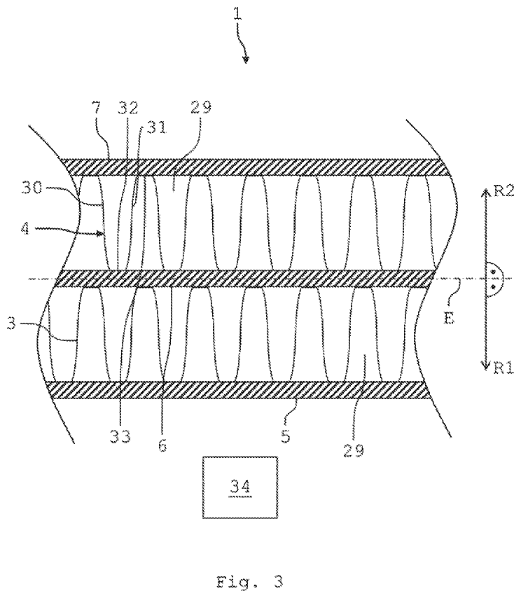

FIG. 3 shows a further schematic sectional view of the plate heat exchanger according to FIG. 1;

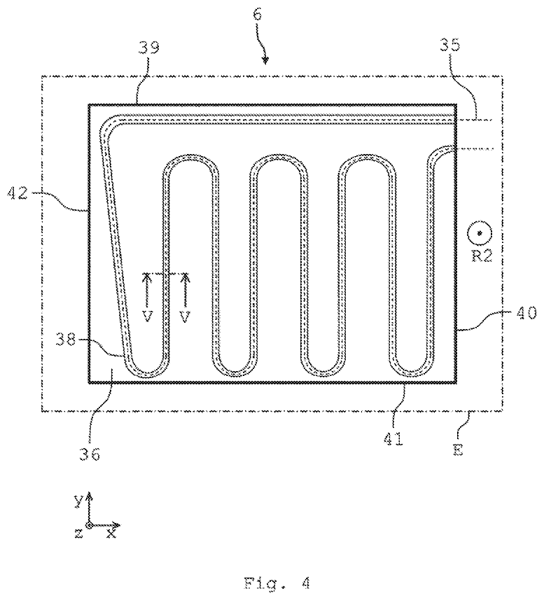

FIG. 4 shows a schematic view of an embodiment of a separating plate for the plate heat exchanger according to FIG. 1;

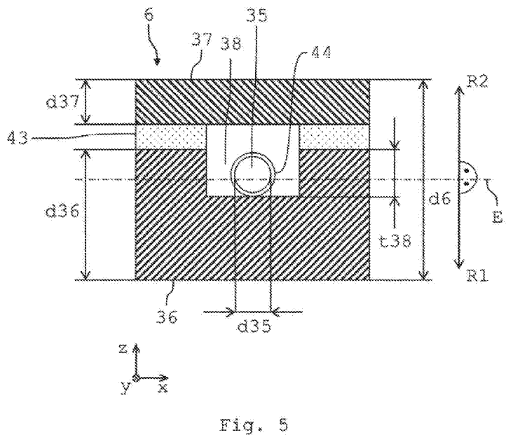

FIG. 5 shows a schematic sectional view of the plate heat exchanger according to the section line V-V in FIG. 4;

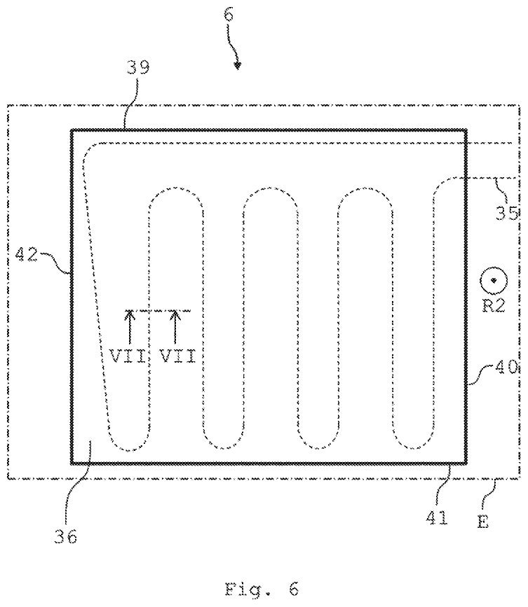

FIG. 6 shows a schematic view of another embodiment of a separating plate for the plate heat exchanger according to FIG. 1;

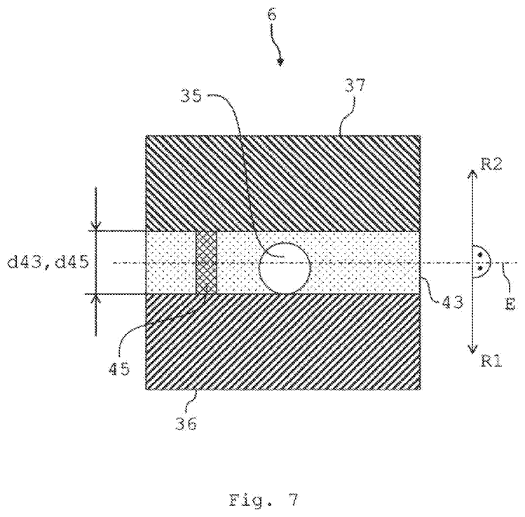

FIG. 7 shows a schematic sectional view of the separating plate according to the section line VII-VII in FIG. 6.

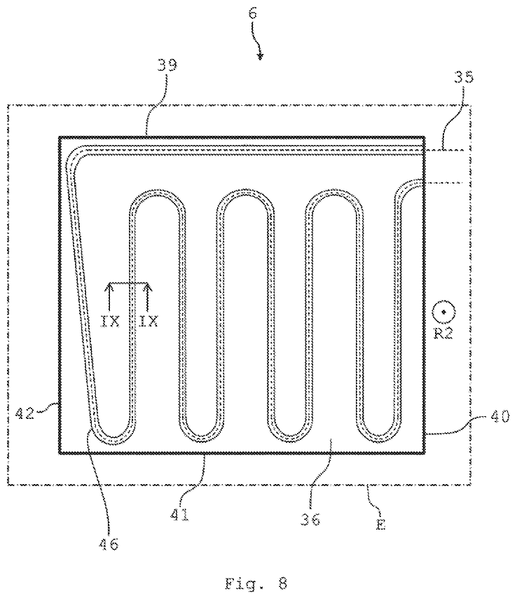

FIG. 8 shows a schematic view of another embodiment of a separating plate for the plate heat exchanger according to FIG. 1;

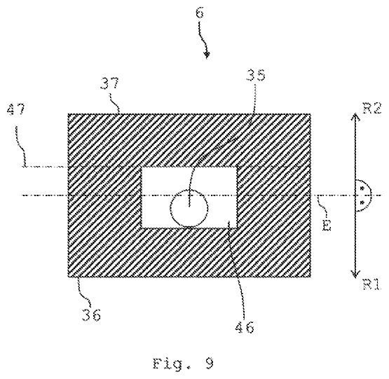

FIG. 9 shows a schematic sectional view of the separating plate according to the section line IX-IX in FIG. 8; and

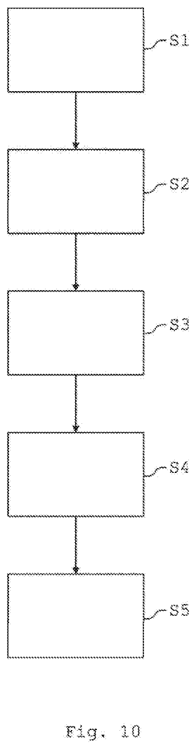

FIG. 10 shows a schematic block diagram of an embodiment of a method for manufacturing the plate heat exchanger according to FIG. 1.

In the figures, the same or functionally equivalent elements have been provided with the same reference symbols unless otherwise stated.

FIGS. 1 and 2 each show a schematic perspectival view of an embodiment of a plate heat exchanger 1. FIG. 3 shows a schematic partial sectional view of the plate heat exchanger 1. In the following, reference is made simultaneously to FIGS. 1 through 3.

The plate heat exchanger 1 is, in particular, a plate fin heat exchanger (PFHE) or can be referred to as such. The plate heat exchanger 1 can be part of a process engineering system 2. The process engineering system 2 can, for example, be a system for air separation or for the production of liquefied natural gas (LNG), a system used in the petrochemical industry, or the like.

The process engineering system 2 can comprise a plurality of such plate heat exchangers 1.

The plate heat exchanger 1 is of parallelepipedal or block-shaped construction and comprises a plurality of lamellae 3, 4 (FIG. 3) and a plurality of separating plates 5 through 7. The lamellae 3, 4 are so-called fins—in particular, heat transfer fins—or can be referred to as fins. The lamellae 3, 4 can be designed as corrugated or ribbed sheets, e.g., as aluminum sheets or steel sheets—in particular, as stainless-steel sheets. The separating plates 5 through 7 are separating sheets or can be referred to as separating sheets.

The separating plates 5 through 7 can be manufactured from, for example, aluminum or steel—in particular, from stainless steel. The number of lamellae 3, 4 and separating plates 5 through 7 is arbitrary.

The plate heat exchanger 1 further comprises cover plates 8, 9, between which the plurality of fins 3, 4 and the plurality of separating plates 5 through 7 are arranged. The cover plates 8, 9 can be constructed identically to the separating plates 5 through 7. Furthermore, the plate heat exchanger 1 comprises so-called sidebars or edge strips 10, 11 which laterally delimit the lamellae 3, 4. The edge strips 10, 11 can be bonded, e.g., soldered or welded, to the separating plates 5 through 7 and/or the lamellae 3, 4. In the case of bonded connections, the connection partners are held together by atomic or molecular forces. Bonded connections are non-releasable connections which can be separated only by destroying the connecting means.

With the aid of the lamellae 3, 4 and the separating plates 5 through 7, the plate heat exchanger 1 forms a plurality of parallel heat transfer passages, in which process media can flow and can indirectly transfer heat to process media guided in adjacent heat transfer passages. The individual heat transfer passages can in each case be charged with a stream of a process medium by means of nozzles 12 through 18 and so-called headers 19 through 28. The headers 19 through 28 may be referred to as manifolds or are manifolds.

As FIG. 3 shows, the lamellae 3, 4 and the separating plates 5 through 7 are arranged alternately. That is to say, a separating plate 5 through 7 is respectively positioned between two plates 3, 4, and a respective plate 3, 4 is positioned between two separating plates 5 through 7. The lamellae 3, 4 and the separating plates 5 through 7 can be connected to one another in a bonded manner. For example, the lamellae 3, 4 and the separating plates 5 through 7 may be soldered or welded together. As mentioned above, the number of lamellae 3, 4 and the number of separating plates 5 through 7 are arbitrary. In this case, the cover plates 8, 9 are positioned on the outside on, in each case, an outermost lamella 3, 4 and thus close the plate heat exchanger 1 to the front and back in the orientation of FIGS. 1 and 2. In FIG. 3, only two lamellae 3, 4—in particular, a first lamella 3 and a second lamella 4—and three separating plates 5 through 7 are shown. The lamellae 3, 4 are constructed identically.

Each separating plate 5 through 7 defines a plane E. In FIG. 3, only one plane E assigned to the separating plate 6 is shown. The plane E runs perpendicular to a drawing plane of FIG. 3 centrally through the separating plate 6. In turn, a first direction R1, which is oriented perpendicular to the plane E, and a second direction R2, which is likewise oriented perpendicular to the plane E, are assigned to the plane E. In the present case, “perpendicular” is to be understood to mean an angle of 90°±10°, more preferably of 90°±5°, more preferably of 90°±1°, and more preferably of exactly 90°. The directions R1, R2 are oriented away from the plane E and in opposite senses with respect to one another. In the orientation of FIG. 3, the first direction R1 is oriented downwards, and the second direction R2 is oriented upwards. Conversely, however, the first direction R1 can also be oriented upwards and the second direction R2 downwards.

As FIG. 3 further shows, the lamellae 3, 4 have a corrugated geometry, so that a plurality of parallel channels 29 are formed. A process medium as mentioned above can flow in the channels 29 of the first lamella 3 and can then come into indirect heat exchange with a process medium guided in a parallel lamella 3, 4—in this case, the second lamella 4. The channels 29 of adjacent lamellae 3, 4 can be oriented in parallel to one another, obliquely to one another, or perpendicular to one another.

The corrugated geometry of the lamellae 3, 4 is formed in that each lamella 3, 4 has a plurality of legs 30, 31 which are arranged parallel to one another and extend, in particular, perpendicular to the separating plates 5 through 7. Furthermore, the lamellae 3, 4 each comprise second legs 32, 33 which are positioned parallel to one another and which connect the first legs 30, 31 in the orientation of FIG. 3 in each case alternately at the top and at the bottom. In this case, the legs 30 through 33 can be rounded to one another, so that the corrugated geometry results. Alternatively, the legs 30 through 33 can also be connected to one another without rounding, so that a stepped geometry of the lamellae 3, 4 results.

A plate heat exchanger 1 as previously explained may be sensitive to thermal stresses. These thermal stresses can be caused by different temperatures of the process media which are in heat exchange. Thermal stresses can lead to mechanical damage to the plate heat exchanger 1 and, in particular, to leakage between the individual heat transfer passages up to leakage with respect to an environment of the plate heat exchanger 1. For this reason, a measuring device 34 is provided, which is set up to measure or detect a time curve of the temperature distribution and/or a strain distribution within the plate heat exchanger 1—in particular, in a spatially-resolved manner.

The measuring device 34 here comprises an optical waveguide 35 (FIG. 4) as the sensor element. The optical waveguide 35 is, in particular, an optical fiber sensor cable.

As FIGS. 4 and 5 show on the basis of the separating plate 6, the optical waveguide 35 (shown in dashed lines in FIG. 4) is embedded in the separating plate 6. The separating plates 5, 7 can, but need not, comprise such an optical waveguide 35. That is, the separating plates 5 through 7 can be constructed identically. However, only the separating plate 6 will be discussed below.

The separating plate 6 may include a first separating plate portion 36 and a second separating plate portion 37. The optical waveguide 35 is arranged between the first separating plate portion 36 and the second separating plate portion 37. The separating plate portions 36, 37 are formed in sheet-like fashion. For example, the separating plate 6 thus has a thickness d6 of approximately 1.4 mm. The optical waveguide 35 itself may have a diameter d35 of about 125 μm. The first separating plate portion 36 has a thickness d36, and the second separating plate portion 37 has a thickness d37. The thicknesses d36, d37 may be the same or different. For example, the thickness d36 is greater than the thickness d37. The plane E preferably runs centrally through the separating plate 6.

A groove 38 in which the optical waveguide 35 is received is provided in the first separating plate portion 36 and/or in the second separating plate portion 37. The groove 38 may be rectangular in cross-section, as shown in FIG. 5. However, the groove 38 may have any geometry. The groove 38 has a depth t38. The depth t38 may be 0.2 mm, for example. As shown in FIG. 4, the groove 38 has a zigzag or meandering shape and extends through at least one of the separating plate portions 36, 37. The separating plate 6 comprises four side edges 39 through 42, but the groove 38 runs into the respective separating plate portion 36, 37 and again runs out of this only at one of the side edges 39 through 42, viz., at the side edge 40. That is, the optical waveguide 35 is guided into and also again out of the separating plate 6 at the side edge 40.

The separating plate 6 comprises an x-direction or width direction x, a y-direction or depth direction y oriented perpendicular to the width direction x, and a z-direction or thickness direction z oriented both perpendicular to the width direction x and perpendicular to the depth direction y. The directions x, y, z form a coordinate system of the separating plate 6. The thicknesses d6, d36, d37 and the depth t38 are measured in the thickness direction z. The thickness direction z can coincide with the second direction R2. The side edges 39, 41 run in the width direction x, and the side edges 40, 42 run in the depth direction y. The plane E is defined, in particular, by the width direction x and the depth direction y of the separating plate 6. The thickness direction z, like the directions R1, R2, is oriented perpendicular to the plane E.

The first separating plate portion 36 and the second separating plate portion 37 are bonded to each other by a solder 43. The solder 43 is provided areally between the first separating plate portion 36 and the second separating plate portion 37. The solder 43 may also fill a cavity formed by the groove 38 between the separating plate portions 36, 37. The optical waveguide 35 can also have a sleeve 44 in which the optical waveguide 35 is accommodated. The optical waveguide 35 is slidably received in the sleeve 44. The sleeve 44 may be made of a metal, for example.

The optical waveguide 35 is now embedded in the separating plate 6 in such a way that the optical waveguide 35, viewed in both directions R1, R2, is covered on two sides or on both sides by material of the separating plate 6.

That is, in the orientation of FIG. 5, the optical waveguide 35, downwards, i.e., in the first direction R1, from the second separating plate portion 36, and upwards, i.e., in the second direction R2, from the first separating plate portion 37, is covered or concealed. In other words, in the orientation of FIG. 5, the first separating plate portion 36, with the viewing direction from below onto the separating plate 6, covers the optical waveguide 35, and the second separating plate portion 37, with the viewing direction from above onto the separating plate 6, covers the optical waveguide 35. In particular, the optical waveguide 35 is covered by material of the separating plate 6, i.e., by the two separating plate portions 36, 37, both in the direction R1 of the first lamella 3 and in the direction R2 of the second lamella 4 (FIG. 3). Due to the embedded optical waveguide 35, the separating plate 6 can be referred to as an intelligent separating plate.

The measuring device 34 is now suitable for detecting or measuring a temperature distribution and/or a strain distribution in the separating plate 6—in particular, in a spatially-resolved manner—with the aid of the embedded optical waveguide 35. For example, the temperature measurement can take place via the evaluation of optical signals such as are produced by Raman scattering. An optical waveguide 35 as explained above is generally made of doped quartz glass (amorphous solid-state structure of mainly silicon dioxide). In such amorphous solid-state structures, lattice vibrations are induced by thermal effects. Such lattice vibrations are temperature-dependent. Light incident on the molecules or particles in the optical waveguide 35 interacts with the electrons of the molecules. These interactions are called Raman scattering. The backscattered light can be divided into three spectral groups.

In addition to Rayleigh scattering, which has the same wavelength as the introduced light, what are known as Stokes and anti-Stokes components exist. In contrast to the Stokes components, which are shifted to higher wavelengths and are temperature-independent, the anti-Stokes components, which are shifted to smaller wavelengths, are temperature-dependent. An intensity ratio between Stokes and anti-Stokes components can thus be used for temperature measurement. The intensity of the two components is obtained over the length of the optical waveguide 35 via a Fourier transformation of these two, backscattered components, in comparison with a Fourier transformation of a reference signal. The temperature for each point of the optical waveguide 35 can thus be determined by comparing the two intensities.

Alternatively, the temperature measurement can take place via the evaluation of optical signals such as are produced by Brillouin scattering of the optical waveguide 35. In this case, the temperature measurement is based upon the spatially-resolved determination of a difference frequency between a primary light wave coupled into the optical waveguide 35 and the wave induced and backscattered in the optical waveguide 35 as a result of Brillouin scattering, the frequency of which wave is reduced relative to the primary wave as a function of the temperature. With a pulsed, irradiated, primary light wave, the frequency shift can, due to the temperature change, be determined in a spatially-resolved manner by time-resolved detection of the signal light for different frequency differences and knowledge of the pulse propagation time. In this case also, the temperature at any point of the optical waveguide 35 can thus also be determined by analyzing the optical signals.

Furthermore, the temperature measurement can take place via the evaluation of optical signals, such as are produced by scattering on a Bragg grating. Bragg gratings are optical band filters which are written into the optical waveguide 35 and can be placed in the optical waveguide 35 more or less as frequently as desired. A center wave number of the band stop results from the so-called Bragg condition. The spectral width of the band stop depends not only upon the grating length and the refractive index, but also upon the temperature. Thus, for a given grating length and refractive index that vary over the optical waveguide 35, one can determine the temperature at the respective location of the Bragg grating over the width of the band stop.

FIGS. 6 and 7 show another embodiment of a separating plate 6. In this embodiment of the separating plate 6, there is no groove 38 as explained above. The separating plate 6 comprises a first separating plate portion 36 as explained above and a second separating plate portion 37, between which the optical waveguide 35 is arranged. The optical waveguide 35 can in turn comprise the previously explained sleeve 44 (not shown in FIG. 7). The first separating plate portion 36 and the second separating plate portion 37 are bonded to each other by means of a solder 43, wherein the optical waveguide 35 or the sleeve 44 is embedded directly in the solder 43.

A supporting structure or a spacer 45 can be provided between the first separating plate portion 36 and the second separating plate portion 37, which prevents damage to the optical waveguide 35 during the assembly of the separating plate 6. The spacer 45 has a thickness d45 which is larger than the diameter d35 (FIG. 5) of the optical waveguide 35. The spacer 45 may be a steel strip. The spacer 45 is embedded in the solder 43. The spacer 45 also determines a thickness d43 of the solder 43. The thickness d45 may, for example, be 170 μm. That is, the thickness d43 of the solder 43 may also, correspondingly, be 170 μm.

FIGS. 8 and 9 show another embodiment of a separating plate 6. In this embodiment of the separating plate 6, said separating plate 6 does not comprise two separating plate portions 36, 37 which are separated from one another and are connected to one another by means of a solder 43. Rather, two separating plate portions 36, 37 are provided integrally—in particular, in one piece. That is, the separating plate portions 36, 37 are formed continuously from the same material and thus inseparably connected to each other.

In this embodiment of the separating plate 6, the optical waveguide 35 is completely surrounded by material of the separating plate 6. The separating plate 6 is formed integrally—in particular, in one piece. For this purpose, the separating plate 6 is produced by means of an additive or generative production method. For example, a powder-based generative manufacturing method—in particular, a 3-D printing method—can be used. For this purpose, the separating plate 6 is constructed from a pulverulent material. This pulverulent material can, for example, be melted in layers with the aid of a laser beam in order to form the separating plate 6. For example, selective laser melting (SLM), selective laser sintering (SLS) or the like may be used as the generative manufacturing method. The fact that the separating plate 6 is produced by means of a generative manufacturing method can be demonstrated microscopically by a layered or layer-by-layer construction of the separating plate 6.

A channel 46 in which the optical waveguide 35 is received is formed in the separating plate 6. The optical waveguide 35 can in turn, as mentioned above, be accommodated in a sleeve 44. The separating plate 6 can be produced, for example, in such a way that the production method for producing the separating plate 6 is carried out in such a way that a lower—in the orientation of FIG. 9—part of the separating plate 6, viz., the first separating plate portion 36, is first produced up to a separating line 47. The channel 46 for the optical waveguide 35 is then provided in the first separating plate portion 36. Optionally, the optical waveguide 35 is inserted into the channel 46 and this is closed with the aid of the manufacturing method by producing the second separating plate portion 37. The integral separating plate 6 produced in this way can then be provided with, for example, a solder layer and be integrated into a conventional production process for producing a plate heat exchanger 1 as explained above.

With the aid of the aforementioned separating plate 6, a high-resolution and exact measurement of the temperature and/or the elongation on or in the separating plate 6 itself can take place. No additional, or only a little additional, installation space is required. There may be no undesirable influence on the measured temperature due to environmental influences, since the separating plate 6 is positioned inside the plate heat exchanger 1. Both expansion and temperature measurement are possible. Different fiber types for the optical waveguide 35 can be selected for this purpose. Several—in particular, different—optical waveguides 35 can also be provided in the separating plate 6. With the aid of the separating plate 6, an increase in the component reliability against failure or against leakages to the inside and to the outside can thus be achieved. The availability of the separating plate 6 is increased. Channels (not shown) provided in the separating plate 6 can also serve to remove material samples, provided that they are connected to the corresponding heat transfer passage.

FIG. 10 shows a schematic block diagram of an embodiment of a method for manufacturing a plate heat exchanger 1 as previously explained. In a step 51, a plurality of lamellae 3, 4 are provided. When the lamellae 3, 4 are provided, undeformed blank sheets can be formed into the corrugated or stepped lamellae 3, 4. In a step S2, a plurality of separating plates 5 through 7 are provided.

In a step S3, at least one optical waveguide 35 is provided. In a further step S4, the optical waveguide 35 is embedded in at least one of the separating plates 5 through 7 viz., for example, in the separating plate 6, such that the optical waveguide 35, as viewed in the first direction R1 and in the second direction R2, is covered on two sides or on both sides by material of the at least one separating plate 6. The lamellae 3, 4 and the separating plates 5 through 7 can then be arranged alternately in a step S5 in order to form the plate heat exchanger 1. In this case, the lamellae 3, 4 and the separating plates 5 through 7 can be soldered or welded together.

The embedding of the optical waveguide 35 can be effected by arranging the optical waveguide 35 between the first separating plate portion 36 and the second separating plate portion 37. The two separating plate portions 36, 37 can be connected to one another in a bonded manner by means of the solder 43. In the process, the optical waveguide 35 can either be embedded in the solder 43, or the optical waveguide is inserted into the groove 38 provided on at least one of the separating plate portions 36, 37 before soldering or welding the two separating plate portions 36, 37. Alternatively, the separating plate 6 can also be constructed around the optical waveguide 35 with the aid of a generative manufacturing method.

Although the present invention has been described with reference to exemplary embodiments, it can be modified in many ways.

### REFERENCE SYMBOLS USED

1 Plate heat exchanger
2 Process engineering system
3 Lamella
4 Lamella
5 Separating plate
6 Separating plate
7 Separating plate
8 Cover plate
9 Cover plate
10 Edge strip
11 Edge strip
12 Nozzle
13 Nozzle
14 Nozzle
15 Nozzle
16 Nozzle
17 Nozzle
18 Nozzle
19 Header
20 Header
21 Header
22 Header
23 Header
24 Header
25 Header
26 Header
27 Header
28 Header
29 Channel
30 Leg
31 Leg
32 Leg
33 Leg
34 Measuring device
35 Optical waveguide
36 Separating plate portion
37 Separating plate portion
38 Groove
39 Side edge
40 Side edge
41 Side edge
42 Side edge
43 Solder
44 Sleeve
45 Spacer
46 Channel
47 Separating line
d6 Thickness
d35 Diameter
d36 Thickness
d37 Thickness
d43 Thickness
d45 Thickness
E Plane
R1 Direction
R2 Direction
S1 Step
S2 Step
S3 Step
S4 Step
S5 Step
t38 Depth
x width direction
y depth direction
z thickness direction

1. Plate heat exchanger (1) for a process engineering system (2), having a plurality of lamellae (3, 4) and a plurality of separating plates (5-7), which are arranged alternately, wherein at least one separating plate (6) has an optical waveguide (35) that is embedded in the at least one separating plate (6) in such a way that the optical waveguide (35) is covered on both sides by material of the at least one separating plate (6) in a first direction (R1) and in a second direction (R2), which are each oriented perpendicular to a plane (E) defined by the at least one separating plate (6) and in opposite senses with respect to one another.

2. Plate heat exchanger according to claim 1, comprising a first lamella (3) and a second lamella (4), wherein the at least one separating plate (6) is arranged between the first lamella (3) and the second lamella (4), and wherein the optical waveguide (35) is embedded in the at least one separating plate (6) in such a way that the optical waveguide (35) is covered by the material of the at least one separating plate (6) both in the direction (R1) of the first lamella (3) and in the direction (R2) of the second lamella (4).

3. Plate heat exchanger according to claim 1, wherein the at least one separating plate (6) has a first separating plate portion (36) and a second separating plate portion (37), between which the optical waveguide (35) is arranged.

4. Plate heat exchanger according to claim 3, wherein the first separating plate portion (36) and the second separating plate portion (37) are bonded to each other by means of a solder (43).

5. Plate heat exchanger according to claim 4, wherein the optical waveguide (35) is embedded in the solder (43).

6. Plate heat exchanger according to claim 3, wherein the first separating plate portion (36) and/or the second separating plate portion (37) have a groove (38) in which the optical waveguide (35) is arranged.

7. Plate heat exchanger according to claim 1, wherein the optical waveguide (35) is completely surrounded by the material of the at least one separating plate (6).

8. Plate heat exchanger according to claim 7, wherein the at least one separating plate (6) is formed in one piece.

9. Plate heat exchanger according to claim 1, wherein the optical waveguide (35) is received in a sleeve (44).

10. Process engineering system (2) having a plate heat exchanger (1) according to claim 1.

11. Method for producing a plate heat exchanger (1) for a process engineering system (2), having the following steps:
a) providing (S1) a plurality of lamellae (3, 4),
b) providing (S2) a plurality of separating plates (5-7),
c) providing (S3) an optical waveguide (35),
d) embedding (S4) the optical waveguide (35) in at least one separating plate (6) in such a way that the optical waveguide (35) is covered on both sides by material of the at least one separating plate (6) in a first direction (R1) and in a second direction (R2), which are each oriented perpendicular to a plane (E) defined by the at least one separating plate (6) and in opposite senses with respect to one another, and
e) alternately arranging (S5) the lamellae (3, 4) and the separating plates (5-7).

12. Method according to claim 11, wherein, in step d), the optical waveguide (35) is arranged between a first separating plate portion (36) and a second separating plate portion (37) of the at least one separating plate (6).

13. Method according to claim 12, wherein, in step d), the first separating plate portion (36) and the second separating plate portion (37) are bonded to each other by means of a solder (43).

14. Method according to claim 13, wherein, in step d), the optical waveguide (35) or a sleeve (44) in which the optical waveguide (35) can be received is embedded in the solder (43) and/or is arranged in a groove (38) having the first separating plate portion (36) and/or the second separating plate portion (37).

15. Method according to claim 11, wherein, in step d), the at least one separating plate (6) is constructed around the optical waveguide (35) with the aid of a generative manufacturing method.
